(19) United States
(12) Patent Application Publication
(10) Pub. No.: US 2013/0270729 A1
(43) Pub. Date: Oct. 17, 2013

(54) RESIN FLOW CONTROL IN VARTM PROCESS

(71) Applicant: Karsten Schibsbye, (US)

(72) Inventor: Karsten Schibsbye, (US)

(21) Appl. No.: 13/445,256

(22) Filed: Apr. 12, 2012

(51) Int. Cl. B29C 45/02; B29C 31/04

(52) U.S. Cl. 264/40.4; 425/130

(57) ABSTRACT

A method for controlling a resin flow in a closed mould cavity during a vacuum assisted resin transfer moulding process is disclosed. The used closed mould cavity includes at least one resin inlet and a number of resin outlets. Each resin outlet is operatively connected to an inlet of a container. Each container includes an outlet which is operatively connected to a vacuum pump. The method includes evacuating the closed mould cavity through the resin outlets by the vacuum pump, injecting liquid resin into the closed mould cavity, measuring the resin fill level in each container during the injection of liquid resin into the closed mould cavity and adjusting the applied pressure at each container outlet depending on the measured resin fill level in the particular container.

### FIELD OF INVENTION

The present invention relates to a method and an apparatus for controlling a resin flow in a closed mould cavity during a vacuum assisted resin transfer moulding process. It further relates to a method for manufacturing a composite structure, for example a wind turbine rotor blade, and to a system for vacuum assisted resin transfer moulding.

### BACKGROUND OF INVENTION

Casting large fibre glass composite structures using a vacuum assisted resin transfer moulding (VARTM) process is well-known within the technical field and it is also known to manufacture wind turbine rotor blades using this process. This is for example described in the document WO 2009/103736 A2. According to this document additional sealed containers are operatively connected to vacuum outlets of the mould cavity and the containers comprise flow sensors so as to measure the airflow from the said outlets. This allows for measuring if and where a leak in the mould cavity may be present.

In a vacuum assisted resin transfer moulding process a number of fibre layers are placed in a first mould shell. After finishing the lay up of the fibre material, and for instance additional components, a closed mould cavity is formed. The closed mould cavity may be formed by means of a second mould shell or by means of a vacuum bag, for example. Then the closed mould cavity is evacuated, for example by means of a vacuum pump, through at least one vacuum outlet. Through a resin inlet uncured fluid resin is injected into the mould cavity due to the pressure difference caused by the evacuation of the closed mould cavity. When the mould cavity is completely filled with resin, the resin is cured to form the composite structure.

### SUMMARY OF INVENTION

Generally, the resin flow inside the closed mould cavity depends on the resistance the resin meets on its way through the fibre material. This means, that areas inside the cavity with fibre material which is not yet saturated by resin may occur while in other areas the fibre material is already completely impregnated or saturated by resin.

A method for controlling a resin flow in a closed mould cavity during a vacuum assisted resin transfer moulding process is described. Further described are a method for manufacturing a composite structure, an apparatus for controlling a resin flow in a closed mould cavity during a vacuum assisted resin transfer moulding process, and a system for vacuum assisted resin transfer moulding.

The method for controlling a resin flow in a closed mould cavity during a vacuum assisted resin transfer moulding process makes use of a closed mould cavity which comprises at least one resin inlet and a number of resin outlets. Each resin outlet is operatively connected to an inlet of a container. In one embodiment each resin outlet is operatively connected to an inlet of a separate container such that each resin outlet is operatively connected to a separate container. However, it is possible that a plurality of outlets are operatively connected to one container. Each container comprises an outlet which is operatively connected to a vacuum pump.

The method comprises the steps of evacuating the closed mould cavity through the resin outlets by means of the vacuum pump, which means by applying vacuum, injecting liquid resin into the closed mould cavity, measuring the resin fill level in each container during the injection of liquid resin into the closed mould cavity, and adjusting the applied pressure, for example vacuum pressure, at each container outlet depending on the measured resin fill level in the particular container.

The method ensures optimal moulding of a composite structure using a vacuum assisted resin transfer moulding process, since the individual pressure at each resin outlet depending on the resin fill level in each container is controlled. Moreover, the float front of the resin in the composite material may be controlled and it is possible to allow a greater impregnation of certain areas of the composite material. Thereby, areas with for example excessive material and/or very dense material may be sufficiently impregnated. The infusion of resin may be stopped at areas which already have been impregnated, but may be continued at areas which are not sufficiently impregnated. This in turn is cost effective as only a little excess resin is drawn out of the mould cavity.

Furthermore, the speed of the float front may at least partly be controlled by, for example, intelligent controlling the level of vacuum in the containers. Thereby, the said speed of the float front may be controlled to suit, for example the avoidable rate of resin supply at the resin inlet.

For example a load cell and/or a level sensor and/or a flow sensor may be used for measuring the resin fill level in each container. This means or these means for measuring the resin fill level in each container may provide its data to a pressure controller, for instance a vacuum control system means. This means that the method may comprise the step of providing data from the measuring the resin fill level in each container to a pressure controller.

For example, a pressure may be applied to each container outlet. The applied pressure may be in between 0.1 bar and 0.3 bar. In another embodiment the applied pressure may 0.2 bar. The pressure at each container outlet mat then be increased depending on the measured resin fill level in the particular container, for example up to a level of between 0.4 and 0.6 bar, for example 0.5 bar.

Furthermore, the pressure at each container outlet may be adjusted such that the resin fill level in the particular container is kept constant at a predetermined positive value, which means that at least a minimal amount of resin is already sucked into the container.

The method for manufacturing a composite structure, for example a wind turbine rotor blade, uses the previously described method, which means that it comprises the steps of the already described method for controlling a resin flow in a closed mould cavity during a vacuum assisted resin transfer moulding process.

The apparatus for controlling a resin flow in a closed mould cavity during a vacuum assisted resin transfer moulding process comprises a number of containers. Each container comprises an inlet for connecting it to a resin outlet of the closed mould cavity.

Each container further comprises an outlet which is connected to a vacuum pump. The apparatus comprises at least one means for measuring the resin fill level in each container and at least one controller for adjusting the pressure, for example of the applied vacuum, at each container outlet.

Generally, the apparatus for controlling a resin flow may be used to perform the previously described methods.

For example, the means for measuring the resin fill level in each container may be a load cell and/or a level sensor and/or a flow sensor. Furthermore, the apparatus may comprise a pressure controller, for instance a vacuum control system means. The pressure controller may be configured for receiving data from the means for measuring the resin fill level in each container and for providing data to the controller for adjusting the pressure of the applied vacuum at each container outlet.

The system for vacuum assisted resin transfer moulding comprises a closed mould cavity with at least one resin inlet and a number of resin outlets. Each resin outlet is operatively connected to an inlet of a container. It is possible for each resin outlet to be operatively connected to one container, or that multiple resin outlets are operatively connected to one container. Each container comprises an outlet which is operatively connected to a vacuum pump. The system comprises at least one means for measuring the resin fill level in each container and at least one controller for adjusting the pressure, for example of applied vacuum, at each container outlet. The at least one controller may be configured for adjusting the pressure at each container outlet depending on the measured resin fill level in the particular container. The system may be configured for manufacturing a wind turbine rotor blade.

The system for vacuum assisted resin transfer moulding may comprise a previously described apparatus for controlling a resin flow in a closed mould cavity during a vacuum assisted resin transfer moulding process.

The pressure level or vacuum level in each vacuum outlet is controlled independently and thereby being enabled to control the flow front between the resin inlet and the outlets. Thereby equal and consistent distribution of resin in the closed mould cavity or in the manufactured laminated structure may be obtained. Moreover, the infusion of resin may be stopped at areas which already have been impregnated, and may be continued at areas which are not sufficiently impregnated. This in turn is cost-effective as only a little excess resin is drawn out of the mould cavity.

### BRIEF DESCRIPTION OF THE DRAWINGS

Further features, properties and advantages will become clear from the following description of embodiments in conjunction with the accompanying drawings. The embodiments do not limit the scope of the present invention which is determined by the appended claims. All described features are advantageous as separate features or in any combination with each other.

FIG. 1 schematically shows a system for vacuum assisted resin transfer moulding.

FIG. 2 schematically shows a vacuum assisted resin transfer moulding at a first instant of time.

FIG. 3 schematically shows the process at a second instant of time.

### DETAILED DESCRIPTION OF INVENTION

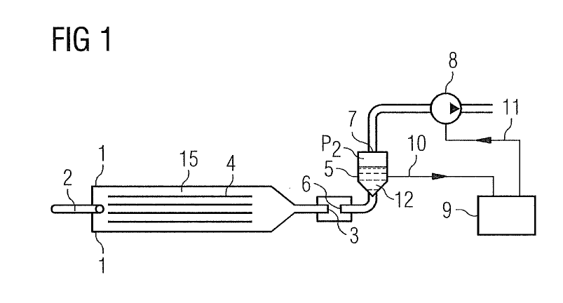

FIG. 1 schematically shows a system for vacuum assisted resin transfer moulding. Fibre material 4, for example glass fibre layers, is placed in a closed mould 1. The closed mould 1 may comprise a lower mould part and an upper mould part or a mould part and a vacuum bag. A closed mould cavity 15, wherein the fibre material is located, is fowled by the closed mould 1. The closed mould 1 further comprises a resin inlet 2 and a number of resin outlets 3.

Each resin outlet 3 is connected to an inlet 6 of a container 5. The container 5 further comprises an outlet 7 which is connected to a vacuum pump 8. According to an embodiment, a resin container 5 is operatively connected to each of the resin outlets 3. According to another embodiment, one or more resin outlets 3, for example 2 or 3 resin outlets, may be connected to one container 5. Thus, a plurality of containers 5 would be provided.

The container 5 is formed so that it receives the mould cavity resin outlet 3 as a container inlet 6 and is operatively connected to a vacuum pump or vacuum system 8 at is outlet 7. Furthermore, the container 5 comprises means for measuring if and how much resin 12 is drawn from the mould cavity 15 to the container 5. This measuring means, which is not explicitly shown in FIG. 1, may be for example a load cell, a level sensor, a flow sensor and the like. Moreover, the means may provide data 10 to a vacuum control system means 9.

The connected vacuum pump or vacuum system 8 may be controlled so as to adjust the applied vacuum pressure and is controlled by said vacuum control system means 9 which receives data from the measuring means. The control of the vacuum pump 8 by means of the controller 9 is indicated by reference numeral 11.

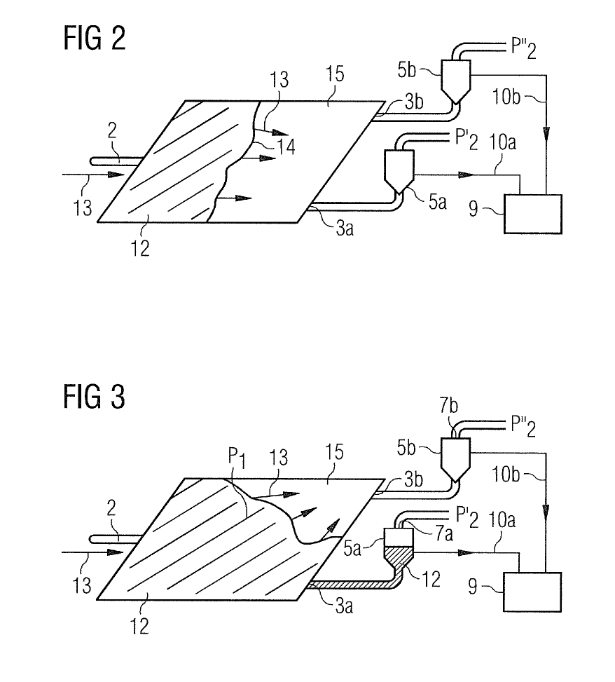

The method for casting a composite structure using a vacuum assisted resin transfer moulding process performed by means of the above-described equipment is schematically described with reference to FIGS. 2 and 3. FIG. 2 schematically shows a vacuum assisted resin transfer moulding at a first instant of time. FIG. 3 schematically shows the process at a second instant of time.

Each resin outlet is connected with a separate container, which means that resin outlet and the respective container are in flow connection. In FIGS. 2 and 3 a first resin outlet 3a is connected to a first container 5a and a second resin outlet 3b is connected to a second container 5b.

In FIG. 2 vacuum, for example a pressure of 0.2 bar, is applied to each of the resin outlets 3a and 3b via the containers 5a and 5b. This means, that at the first resin outlet 3a a pressure p₂′=0.2 bar is applied and at the second resin outlet 3b a pressure p₂″=0.2 bar is applied. Caused by this pressure reduction resin 12 is sucked through the resin inlet 2 into the closed mould cavity 15. The flow direction of the resin is indicated by arrows 13. The float front is indicated by reference numeral 14. Resin is drawn into the composite fibre material located in the mould cavity from a resin reservoir, for example at 1 bar pressure.

Initially the amount of resin in all containers 5a and 5b connected to the resin outlets 3a and 3b is zero as the composite fibre material 4 is not saturated, for instance locally or globally, with resin 12. As shown in FIG. 2, the resin float front 14 is built up in the composite material 4. The float front 14 takes its form after which “resistance” the resin 12 meets on its way through the fibre material 4. In other words, the more “resistance” the slower is the movement of the float front 14. The pressure on the “backside” of the float front 14 is higher, which means less vacuum, than on the “front side” due to the atmospheric pressure which drives the resin 12 towards the resin outlets 3a and 3b.

After some time the float front 14 may have reached one or more of the resin outlets 3a or 3b and resin 12 is drawn into the respective containers 5a or 5b. This situation is schematically shown in FIG. 3. In FIG. 3 the resin 12 has passed the first outlet 3a and has partly filled the container 5a. The amount of resin 12 in the containers 5a and 5b is measured by measuring means, for example load cells, level sensors, flow sensors etc. The measured data 10a and 10b are provided to the pressure control system or vacuum control system 9. The vacuum control system 9 then individually regulates the vacuum pressure in each container 5a or 5b in order to keep a constant level of resin 12 in the respective container 5a or 5b.

In the situation shown in FIG. 3 the applied pressure p₂′ at the first container 5a was increased from 0.2 bar up to 0.5 bar, which corresponds to the pressure p₁=0.5 bar at the “backside” of the float front 14 in the closed mould cavity 15. By increasing the pressure to 0.5 bar the amount of resin 12 in the first container 5a is kept at a constant level. Hereby it is achieved that the float front 14 may be directed towards the fibre material which is not yet saturated by resin and towards to the second resin outlet 3b. Generally, the vacuum control system 9 individually regulates the vacuum pressure p₂ in each container 5, for example in order to keep a constant level of resin 12 in the container 5.

1. A method for controlling a resin flow in a closed mould cavity during a vacuum assisted resin transfer moulding process, wherein the closed mould cavity comprises at least one resin inlet and a plurality of resin outlets, each resin outlet being operatively connected to an inlet of a container, each container comprising an outlet which is operatively connected to a vacuum pump, the method comprises:
evacuating the closed mould cavity through the resin outlets via the vacuum pump;
injecting liquid resin into the closed mould cavity;
measuring the resin fill level in each container during the injection of liquid resin into the closed mould cavity; and
adjusting the applied pressure at each container outlet depending on the measured resin fill level in the particular container.

2. The method as claimed in claim 1,
wherein the measuring the resin fill level in each container is via at least one of the devices selected from the group consisting of a load cell, a level sensor, and a flow sensor for measuring.

3. The method as claimed in claim 1,
providing data from the measuring the resin fill level in each container to a pressure controller.

4. The method as claimed in claim 1, comprising:
applying a pressure between 0.1 bar and 0.3 bar to each container outlet; and
increasing the pressure at each container outlet based on the measured resin fill level in the particular container.

5. The method as claimed in claim 1, comprising:
wherein the adjusting the pressure at each container outlet is such that the resin fill level in the particular container is kept constant at a predetermined positive value.

6. An apparatus for controlling a resin flow in a closed mould cavity during a vacuum assisted resin transfer moulding process, comprising:
a plurality of containers each of which comprises an inlet connectable to a resin outlet of the closed mould cavity and an outlet which is connected to a vacuum pump;
at least one means for measuring the resin fill level in each container; and
at least one pressure controller operatively connected to the at least one means for measuring and to at least one of the plurality of containers, the at least one pressure controller adjusts the pressure at each connected container outlet based on the measured resin fill.

7. The apparatus as claimed in claim 6,
wherein the means for measuring the resin fill level in each container is a load cell, a level sensor, or a flow sensor.

8. A system for vacuum assisted resin transfer moulding, comprising
a closed mould cavity, comprising:
a vacuum pump;
a plurality of containers each including an inlet and an outlet, the outlet operatively connected to the vacuum pump;
at least one resin inlet, and
a plurality of resin outlets, each resin outlet is operatively connected to the inlet of one of the plurality of containers;
at least one means for measuring the resin fill level in each container; and
at least one controller for adjusting the pressure at each container outlet.

9. The system as claimed in claim 8,
wherein the means for measuring the resin fill level in each container is a load cell, a level sensor, or a flow sensor.

10. The system as claimed in claim 8,
wherein the system is configured for manufacturing a wind turbine rotor blade.
